(19) United States
(12) Patent Application Publication
(10) Pub. No.: US 2011/0057799 A1
(43) Pub. Date: Mar. 10, 2011

(54) HAND WASHING MONITORING SYSTEM

(76) Inventor: Yordan Gineff Taneff, Lantana, FL (US)

(21) Appl. No.: 12/873,870

(22) Filed: Sep. 1, 2010

Related U.S. Application Data
(60) Provisional application No. 61/275,582, filed on Sep. 1, 2009.

(51) Int. Cl. G08B 23/00

(52) U.S. Cl. 340/573.1

(57) ABSTRACT

A hand cleansing monitoring system that electronically monitors and communicates hand washing frequency and procedures to management through a computer based system.

### CROSS REFERENCE TO RELATED APPLICATIONS

This application claims the benefit of provisional patent application Ser. No. 61/275,582 filed Sep. 1, 2009.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

This invention relates generally to a hand washing monitoring system, and more particularly, to a hand washing monitoring system that monitors, processes and records information in a central computer system and database that indicates whether an employee in a restaurant, medical or similar business requiring proper hygiene has properly washed their hands to determine compliance with government hand washing requirements.

2. Description of the Background Art

Infections, germs, viruses, such as Hepatitis A, and other infections are spread through ingesting food or drinks handled by a person whose hands are contaminated. So, employees in the food service industry or medical industry, who either do not wash their hands or improperly wash their hands after using rest room facilities or handling unsterilized objects, are the main agents of transfer of that and other types of infections to the general population. According to Center for Disease Control, hand washing is the single most important means of preventing the spread of infection and disease. Nationally, it is estimated that food borne illness kills 5,000 people a year and 5 million more become ill. Washing hands correctly will greatly reduce chances of spreading germs and can reduce food borne illnesses, which add to health care costs in excess of $4 billion a year in the U.S. In the recent past alone there was an outbreak of Hepatitis A that killed 3 people and sickened 600. All of this could have been prevented by having the infected person properly wash his or her hands. Hospital patients also suffer from improper hygiene. Hospital acquired infections kill 100,000 people a year in the United States alone and cause extended hospital stays of 2,000,000 million patients. Information on the subject matter from different governmental sources, food, health care, industries, etc., are too numerous to present in a patent application and could be obtained on the Internet or in a library.

Both monitoring hand washing through the use of radiofrequency (“RF”) technology and the use of mobile RF units to transfer information from one RF unit to another and to a computer data base for the purpose of monitoring hand washing have not been disclosed as contemplated by the instant invention disclosed herein. While efficiently and effectively monitoring hand washing is theoretically possible, there is a need to make it practical to monitor hand washing at an affordable price to minimize the spread of infectious diseases or viruses to patrons in restaurants or between patients in hospitals, as well as to employees, and the general public. For instance, the handling of food with unclean hands in restaurants is well known to increase the risks of spreading infections and salmonella. Hospital acquired infections cause the premature deaths of 100,000 patients per year in the United States alone (and probably—1,000,000 or more worldwide) and extended hospital stays of 2,000,000 patients per year in the United States (and probably—20,000,000, or more worldwide). While the prior art teaches that the monitoring of hand washing, at least within a hospital setting, could be achieved by monitoring the specific location of employees, patients, and equipment at any given time through constant communication with a master station that determines compliance or non-compliance with hand washing protocol and provides statistical analysis, it does not account for specific or sporadic hand washing practices or “chance encounters.” Prior art systems such as these do not provide an useful information to determine whether an employee has actually washed their hands and therefore is unreliable. As such, there exists a need for a system that monitors true compliance by obtaining and processing data for every washing done and from every encounter an employee has with a place, patient or contaminated object and determines compliance or non-compliance with hand washing requirements.

If there existed a system that reduced the transfer of germs, bacteria and infections, it would result in a reduction of illnesses and deaths, health expenditures and hospital costs, as well as a reduction in hospital insurance premiums and would address these issues. An electronic system that could monitor and promote compliance with proper hand-washing requirements at the workplace would be well received. However, there are no systems known that adequately and reliably monitor employee hand washing in restaurants or hospitals or other places where clean hands are a necessity. Therefore, there exists a need for an electronic microcontroller based hand washing monitoring system that would promote proper hand washing practices in restaurants, hospitals, schools or other places where clean hands are a necessity to prevent the spread of germs, bacteria and infections. It is, therefore, to the effective resolution of the aforementioned problems and shortcomings of the prior art that the present invention is directed. The instant invention addresses this unfulfilled need in the prior art by providing an electronic hand washing system as contemplated by the instant invention disclosed herein.

### BRIEF SUMMARY OF THE INVENTION

In light of the foregoing, it is an object of the present invention to provide a hand washing monitoring system that reliably monitors whether employees actually wash their hands.

It is a further object of the instant invention is to have employees or other individuals use proper hygiene at their place of employment or visit.

It is also an object of the instant invention to provide a hand washing monitoring system for reliably monitoring whether employees actually wash their hands that is electronic.

It is another object of the instant invention to provide a hand washing monitoring system that reliably monitors whether employees actually wash their hands and that is adapted for use in the restaurant, hospital and school environments.

It is an additional object of the instant invention to provide a hand washing monitoring system that uses RFID.

It is yet another object of the instant invention to provide a hand washing monitoring system that is computer or microcontroller based.

It is yet an additional object of the instant invention to provide a hand washing monitoring system that is reliable and cost effective.

It is yet a further object of the instant invention to provide a hand washing monitoring system that records and processes actual hand washing times, duration and procedure to enable evaluation of employee hand washing practices.

In light of these and other objects, the instant invention comprises is an electronic hand washing monitoring system for use in restaurant restrooms, hospitals and other locations where hand cleansing is a necessity to avoid the spread of germs, bacteria and infections. The instant invention comprises an electronic system in the field of healthcare, food processing, food service, and other industries where clean hands are mandatory and is thus related to maintaining proper hygiene in any work environment. It is an electronic hand-washing monitoring system that may be installed in restrooms, sensitive hospital areas and other areas requiring proper hand washing practices. The instant invention comprises an RFID based system (Radio Frequency Identification Units) having sensors and microcontrollers that receive and, or transmits electronic signals that are processed by a computer or other microcontroller to determine whether an employee has actually washed their hands. Washing habits are also processed by the instant invention to achieve the main objective of advancing proper hygiene practices. A main database including every individual's specific data in regard to his/her compliance with hand-washing requirements is maintained in a central computer for management to review and analyze.

A significant difference between the teachings in prior art and the instant invention is that known systems track tendencies and not actual hand washing sessions. Known systems are not able to record and process every hand washing activity. The instant invention comprises a system that monitors all hand washing sessions and determines compliance or non-compliance with hand washing requirements. The instant invention achieves its objectives by using RFID (radiofrequency identification unit) attached or imbedded in one or more items worn by employees. The instant invention includes a database computer that rearranges the data in a format that is convenient to review and analyze by the management. Another major difference between the teachings in prior art and instant invention is that the monitoring of hand washing is being achieved through the use of short range RF transmissions, such as with a radius of transmission from two to three feet.

The instant invention provides an improved quantitative analysis that is used in preventing the spread of disease to patients in hospitals, employees and the general population. Prior to the instant invention proper hygiene at the work place was left up to the conscience of the employees. The instant invention gives management a tool to supervise proper hygiene practices in accordance with required protocol.

One of the main objectives achieved by the instant invention is the monitoring of employees to determine if they properly washed their hands after using a rest room facility or touching an unsterilized object prior to performing their duties. One of the main advantages of my invention is that it provides the ability of both management of any establishment and overseeing governmental authorities to monitor employees' proper hygiene at work remotely just by checking the data entered into a computer data base. That will improve the monitoring capability of a company management and government employees alike, both quantitatively and qualitatively. Also, another major improvement of the health of the general population could be achieved if and when the use of my invention becomes codified nationwide in the United States and abroad.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is an illustrative view of the hand washing monitoring system in accordance with the preferred embodiment of the instant invention.

FIG. 2 is a diagram view of the electronic components of the RFID (radiofrequency identification unit) components in accordance with the preferred embodiment of the instant invention.

FIG. 3 is a diagram view of the electronic components of the RFDU (radiofrequency door unit) components in accordance with the preferred embodiment of the instant invention.

FIG. 4 is a diagram view of the electronic components of the RFSU-1 (radiofrequency sanitization unit) components in accordance with the preferred embodiment of the instant invention.

FIG. 5 is a diagram view of the electronic components of the peripheral components of RFSU-1 (radiofrequency sanitization unit-1) in accordance with the preferred embodiment of the instant invention.

FIG. 6 is a diagram view of the main electronic components of the main components of the RFSU-2 (radiofrequency sanitization unit-2) in accordance with the preferred embodiment of the instant invention.

FIG. 7 is a diagram view of the electronic components of the main components of RFCU-1 (radiofrequency contamination unit-1) in accordance with the preferred embodiment of the instant invention.

FIG. 8 is a diagram view of the electronic components of the main components of RFCU-2 (radiofrequency contamination unit-2) in accordance with the preferred embodiment of the instant invention.

FIG. 9 is a diagram of illustrating the theory of operation” in accordance with the preferred embodiment of the instant invention.

### DETAILED DESCRIPTION OF THE INVENTION

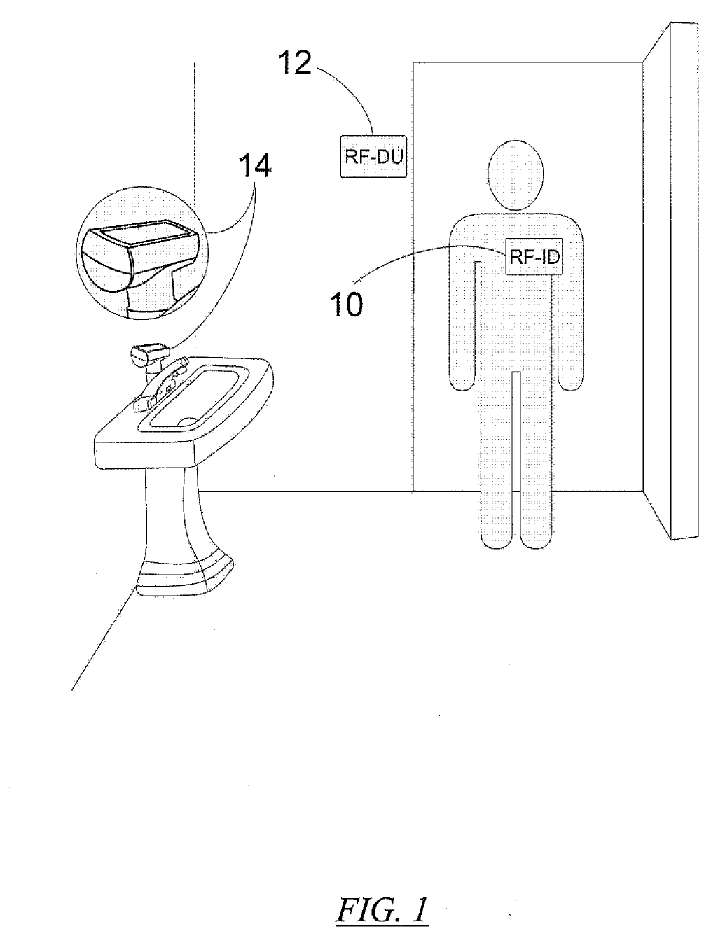

With reference to the drawings, FIGS. 1 to 9 depict the preferred embodiment of the instant invention which is generally referenced as a hand washing monitoring system and, or by numeric character 10. The instant invention 10 is disclosed based on reference numerals as follows:

### REFERENCE NUMERALS FOR FIG. 1

10—RFID (radiofrequency identification unit)
12—RFDU (radiofrequency door unit)
14—RFSU 1 (radiofrequency sanitization unit 1)

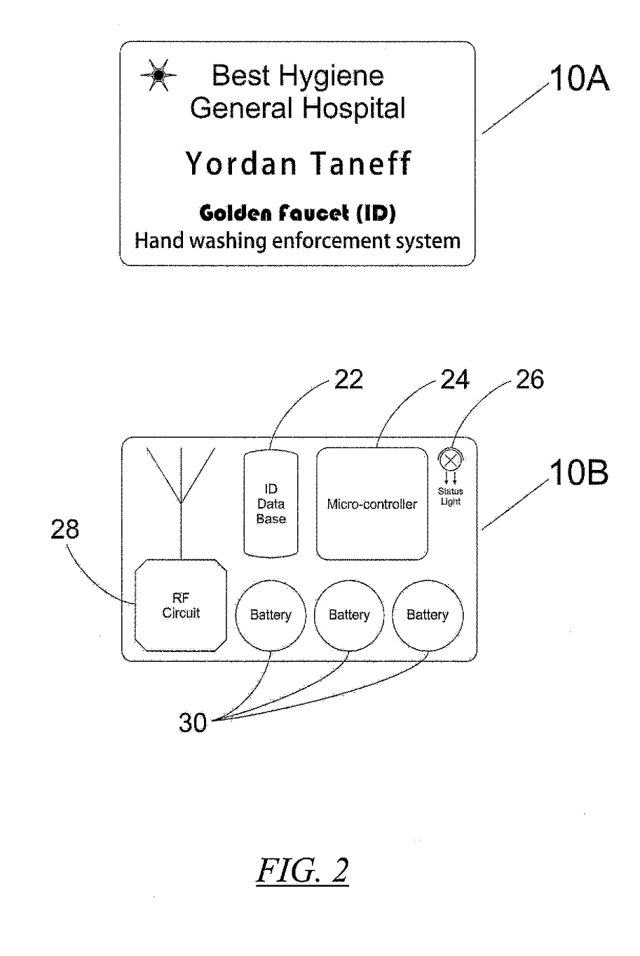

### REFERENCE NUMERALS FOR FIG. 2

10—RFID (radiofrequency identification unit)
22—RFID data base
24—RFID microcontroller
26—RFID status light
28—RFID radiofrequency circuit
30—RFID battery

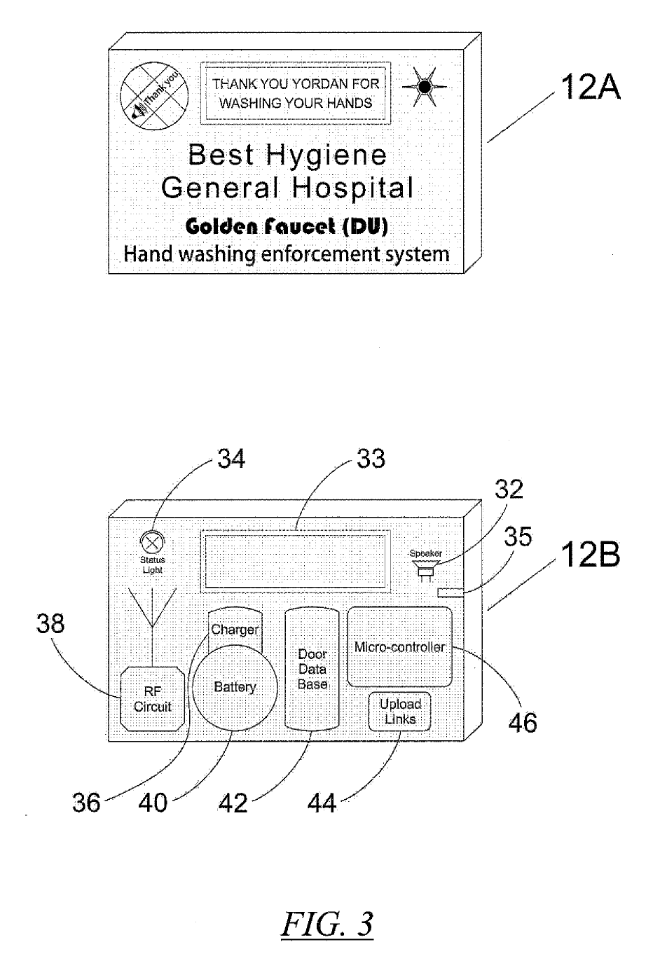

### REFERENCE NUMERALS FOR FIG. 3

12—RFDU (radiofrequency door unit)
32—RFDU speaker
33—RFDU LCD (liquefied crystal display)
34—RFDU status light
35—RFDU entry/exit sensors
36—RFDU battery charger
38—RFDU radiofrequency circuit
40—RFDU battery
42—RFDU data base
44—RFDU upload links
46—RFDU microcontroller

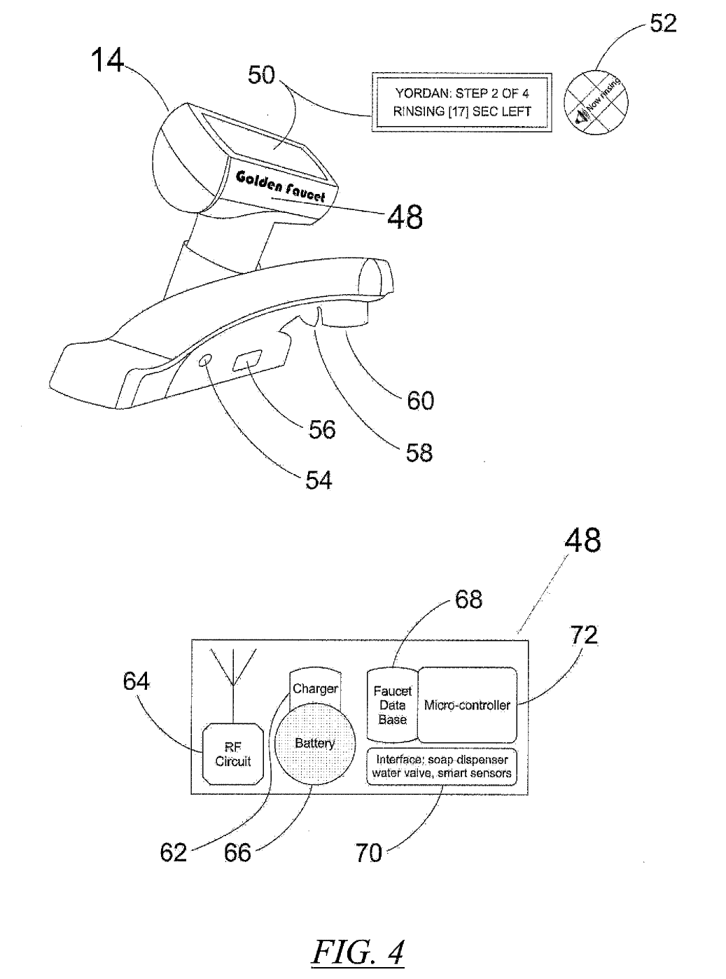

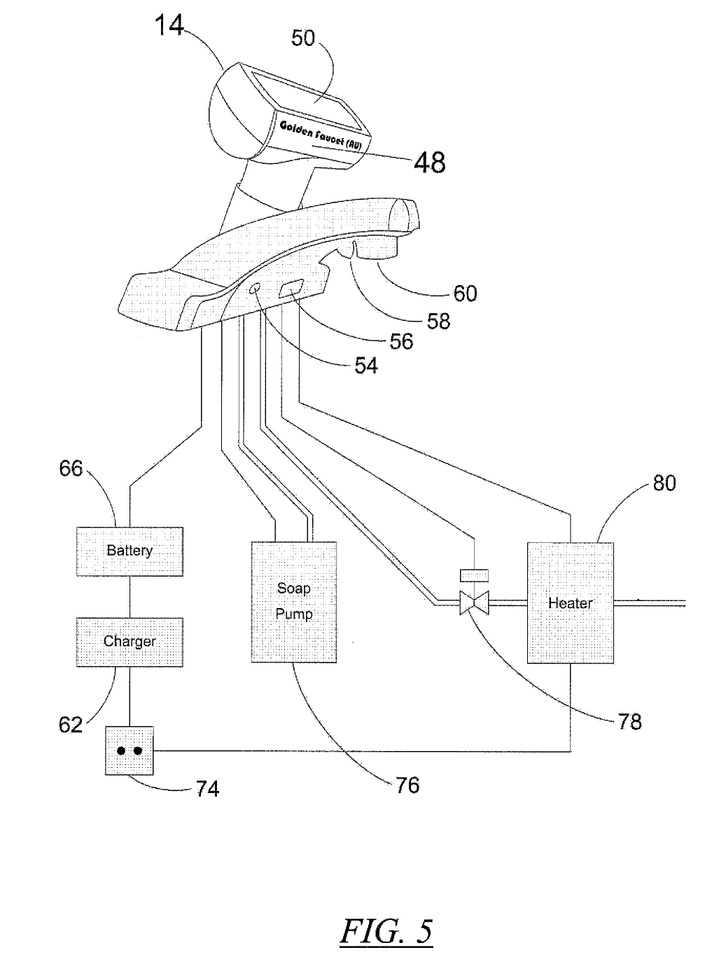

### REFERENCE NUMERALS FOR FIGS. 4 AND 5

14—PCB for RFSU-1 [embedded in faucet (48)]
48—RFSU-1 faucet
50—RFSU-1 LCD (liquefied crystal display)
52—RFSU-1 speaker
54—RFSU-1 motion sensor
56—RFSU-1 motion detector
58—RFSU-1 cleaning substance dispenser spout
60—RFSU-1 water spout
62—RFSU-1 battery charger
64—RFSU-1 radiofrequency circuit
66—RFSU-1 battery
68—RFSU-1 data base
70—RFSU-1 interface
72—RFSU-1 microcontroller
74—RFSU-1 power supply
76—RFSU-1 cleaning substance dispenser
78—RFSU-1 electric valve
80—RFSU-1 tankless water heater

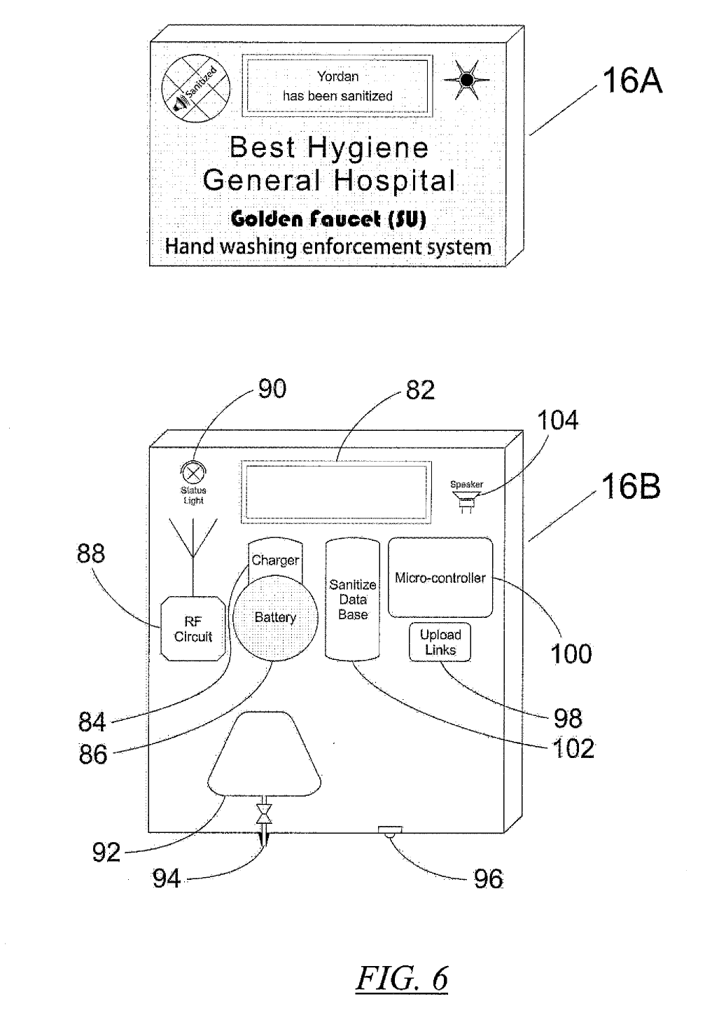

### REFERENCE NUMERALS FOR FIG. 6

16—PCB for RFSU-2 (radiofrequency activation unit 2)
82—RFSU-2 LCD (liquefied crystal display)
84—RFSU-2 battery charger
86—RFSU-2 battery
88—RFSU-2 radiofrequency circuit
92—RFSU-2 cleaning substance dispenser
94—RFSU-2 motion sensor
96—RFSU-2 motion detector
98—RFSU-2 interface
100—RFSU-2 microcontroller
102—RFSU-2 data base
104—RFSU-2 speaker

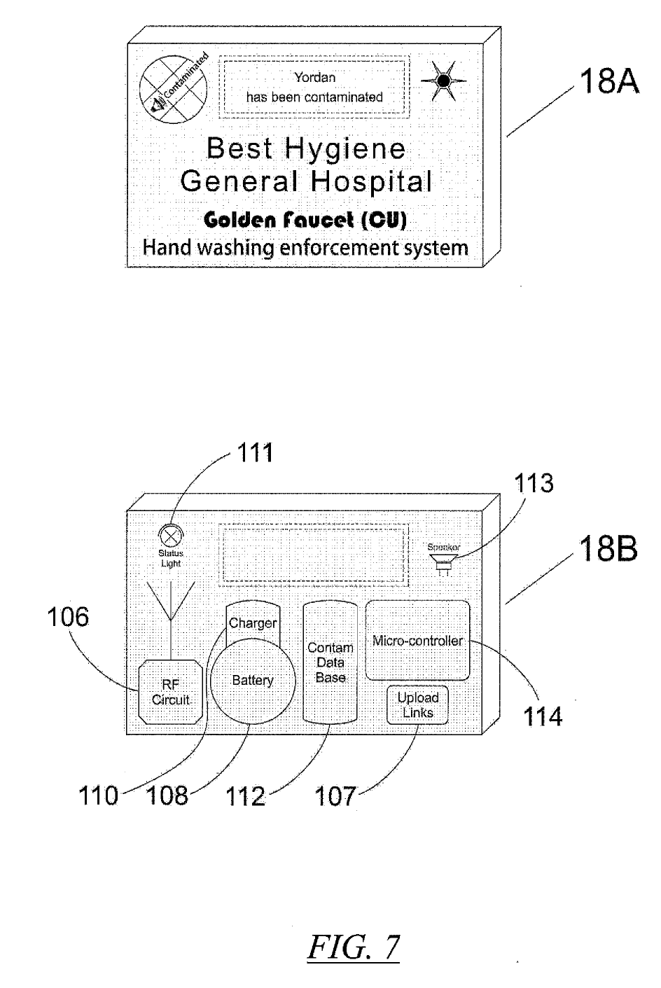

### REFERENCE NUMERALS FOR FIG. 7

18—RFCU-1 (radiofrequency contamination unit 1)
106—RFCU-1 radiofrequency circuit
107—RFCU-1 upload link
108—RFCU-1 battery
110—RFCU-1 battery charger
111—RFCU-1 status light
112—RFCU-1 data base
113—RFCU-1 speaker
114—RFCU-1 microcontroller

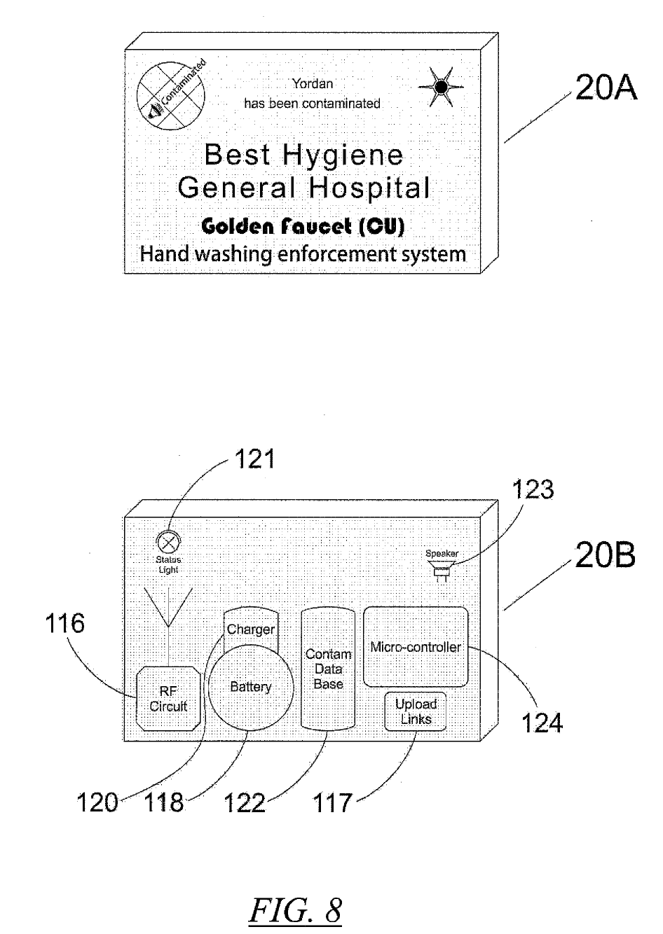

### REFERENCE NUMERALS FOR FIG. 8

20—RFCU-2 (Radio Frequency Contamination Unit 2)
116—RFCU-2 radiofrequency circuit
117—RFCU-2 upload link
118—RFCU-2 battery
120—RFCU-2 battery charger
121—RFCU-2 status light
122—RFCU-2 data base
123—RFCU-2 speaker
124—RFCU-2 microcontroller
   An alternative embodiment of the instant invention comprises a system that monitors proper hand washing in a restroom and consists of three main units and one optional unit (see FIGS. 1, 2, 3, 4, 5, and 6):
1. RFID [radiofrequency identification unit (10)—see FIG. 2]. The main building blocks of RFID are:
   a. RFID microcontroller (24)
   b. RFID radiofrequency circuit (28)
   c. RFID data base (28)
   d. RFID battery (30)
   e. RFID status light (26)
2. RFDU [radiofrequency door unit (12)—see FIG. 3]. The main building blocks of RFDU are:
   a. RFDU microcontroller (46)
   b. RFDU radiofrequency circuit (38)
   c. RFDU data base (42)
   d. RFDU battery (40)
   e. RFDU battery charger (36)
   f. RFDU upload links (44)
   g. RFDU speaker (32)
   h. RFDU LCD (liquefied crystal display) (33)
   i. RFDU status light (34)
   j. RFDU entry/exit sensors (35)
3. RFSU-1 (radiofrequency sanitization unit 1—see FIGS. 4 and 5). The main building blocks of RFSU-1 are:
   a. PCB for RFSU 1 (14) [embedded in faucet (48)]
   b. RFSU-1 faucet (48)
   c. RFSU-1 LCD (liquefied crystal display) (50)
   d. RFSU-1 microcontroller (72)
   e. RFSU-1 motion sensor (54)
   f. RFSU-1 motion detector (56)
   g. RFSU-1 cleaning substance dispenser spout (58)
   h. RFSU-1 water spout (60)
   i. RFSU-1 battery charger (62)
   j. RFSU-1 radiofrequency circuit (64)
   k. RFSU-1 battery (66)
   l. RFSU-1 data base (68)
   m. RFSU-1 interface (70)
   n. RFSU-1 speaker (52)
   o. RFSU-1 power supply (74)
   p. RFSU-1 cleaning substance dispenser (76)
   q. RFSU-1 electric valve (78)
   r. RFSU-1 tankless water heater (80)
4. RFSU-2 (radiofrequency sanitization unit 2—see FIG. 6) (optional). The main building blocks of RFSU-2 are:
   a. PCB for RFSU 2 (radiofrequency sanitization unit 2) (16)
   b. RFSU-2 LCD (liquefied crystal display) (82)
   c. RFSU-2 battery charger (84)
   d. RFSU-2 battery (86)
   e. RFSU-2 radiofrequency circuit (88)
   f. RFSU-2 cleaning substance dispenser (92)
   g. RFSU-2 motion sensor (94)
   h. RFSU-2 motion detector (96)
   i. RFSU-2 interface (98)
   j. RFSU-2 microcontroller (100)
   k. RFSU-2 data base (102)
   l. RFSU-2 speaker (104)
      The preferred embodiment of the instant invention 10 comprises a system that monitors proper hand washing in an entire business entity. Examples of business entities in need of monitoring hand washing would be hospitals, food processing plants, hotels, restaurants, and many others. The primary embodiment consists of six main units. The first four units are identical to the four units described in the Alternative embodiment above, i.e. RFID (see item 1 above), RFDU (see item 2 above), RFSU-1 (see item 3 above), RFSU-2 (see item 4 above), and the last two units are listed below:
5. RFCU-1 (radiofrequency contamination unit 1—see FIG. 7). The main building blocks of RFCU-1 are:
   a. PCB of RFCU-1 (radiofrequency contamination unit 1) (18)
   b. RFCU-1 radio frequency circuit (106)
   c. RFCU-1 battery (108)
   d. RFCU-1 battery charger (110).
   e. RFCU-1 data base (112)
   f. RFCU-1 microcontroller (114)
6. RFCU-2 (radiofrequency contamination unit 2—see FIG. 8). The main building blocks of RFCU-2 are:
   a. PCB of RFCU-2 (radiofrequency contamination unit 2) (20)
   b. RFCU-2 radiofrequency circuit (116)
   c. RFCU-2 battery (118)
   d. RFCU-2 battery charger (120)
   e. RFCU-2 data base (122)
   f. RFCU-2 microcontroller (124)
      With respect to operation, the Alternative embodiment of the instant invention 10 is an electronic hand-washing monitoring system that will be installed at restroom areas in food and healthcare facilities, such as restaurants and hospitals, as well as any other facility, which requires monitoring of hand washing after using a restroom. The system uses RF (radiofrequency) identification technology to establish communication between its three main units as well as the optional unit. The system also uses embedded microcontrollers to achieve its control functionality. The main database including the individual's specific data is maintained in a central computer and gathered from the various monitoring systems within the building via RF data transfer technology. Data is communicated to the users via backlit LCD display and voice prompts.

The system of this embodiment comprises the following main units as depicted in FIG. 1, as follows:
1. RFID (radiofrequency identification unit) (10). Each employee wares his/her own unique RFID badge which holds the identification information about the employee and his/her recent history of hygiene compliance.
2. RFDU (radiofrequency door unit) (12). This unit is mounted at the entrance of each restroom facility within the building, such as a restaurant, or a hospital, or others. Its prime function is to detect the employee at each entry and exit to and from the restroom. It visually and audibly alerts the employee at the exit if he/she did not get engaged with the hand washing enforcement process at the faucet, RFSU.
3. RFSU-1 (radiofrequency sanitization unit 1) (14). This unit is embedded within the faucet assembly and is capable of identifying the employee when he/she approaches the faucet to wash his/her hands, of engaging said employee in the hand washing process, of detecting if said employee successfully completed the hand washing process, of visually and audibly alerting said employee of his/her pass/fail status, and of stamping the RFID of said employee with said pass/fail status. Monitoring of the hand washing process consists of monitoring the dispensation of cleaning substance, the duration of hand rubbing, and the duration of hand rinsing through the use RFSU-1 motion sensor (54) and RFSU-1 motion detector (56).
4. RFSU-2 (radiofrequency sanitization unit 2) (16) is an optional unit with very similar functionally to the RFSU-1 (see FIG. 6). The main difference between the two units is that RF SU-2 uses hand cleansing substances that do not require running water for rinsing them off, like alcohol based cleansers. All other functions are identical to RFSU-1. In most, but not all, instances the use of RFSU-2 is allowable instead of the use of RFSU-1. Monitoring of the hand cleaning process consists of monitoring the dispensation of cleaning substance, and the duration of hand rubbing, through the use RFSU-2 motion sensor (94) and RFSU-2 motion detector (96).

The RFID (radiofrequency identification unit) (10) is the employee badge which must be worn all the time during working hours. It emits detectable RF waves within a radius of two feet or so and has the size of a name tag or a credit card. The RFID holds the employee name and his/her history of all visits to the restrooms. The RFID consists of the following components as shown in FIG. 2
A. RFID microcontroller (24).
B. RFID database (28) to store the hygiene history of the employee.
C. RFID radiofrequency circuit (28) with transceiver and embedded antenna.
D. RFID status tri-color light (26), flashing orange (in the rest room), alternating green/red (engaged with AU), flashing green (passed), and flashing red (failed).
E. RFID battery (30) with one-year life span.
   The functionality and capability of the RFID (10)
1. Communicates with the RFDU at every entry to get time-stamped.
2. It keeps the time while within the restroom
3. Communicates with the RFAU to acknowledge the employee's engagement with the hand washing process.
4. It receives the pass/fail status of compliance from the RFSU and keeps it.
5. Communicates with the RFDU at each exit and reports the pass/fail status.
6. The use of the RFID to carry data from the RFSU to the RFDU
The RFID badge itself is the communication link between the RFSU (sanitization, or wash station, unit) and the RFDU (door unit). This approach is important so we keep all three RF transceivers, RFID, RFDU, and RFSU at a minimum transmission power of detectable RF waves within a radius of two feet or so. This way we avoid various systems from interfering with each other if they are too close, such as two bathrooms on two different floors but the same vertical position.

The RFDU (radiofrequency door unit) (12) is the main control device, which is mounted inside the wall in an electric box size of enclosure, close to the restroom entrance door frame. It emits detectable RF waves within a radius of two feet or so. It is normally off and gets turned on by the entry/exit sensors (35), which are normally on, any time an employee enters or exits the restroom in order to communicate with the employee's RFID. The RFDU keeps the hygiene history file for all engaged employees until this history file is uploaded to the company's main computers for the management to review. The RFDU consists of the following components as shown in FIG. 3:
A. RFDU microcontroller (46),
B. RFDU database (42) to store the hygiene history of all employees, who enter the restroom.
C. RFDU radiofrequency circuit (38) with a transceiver and an internal antenna to communicate with the RFID
D. RFDU upload link (44) to upload the data to the company's main computer. This could be of any possible form, USB, Ethernet, Phone, or wireless.
E. RFDU LCD (liquefied crystal display) (33). Large back-lit LCD to display names and the appropriate message of welcoming at each entrance or appreciation/warning at each exit.
F. RFDU speaker (32). A speaker for added audible messaging.
G. RFDU Status tri-color light (34), flashing orange (some employees in the rest room), flashing green (exiting employee passed), and flashing red (exiting employee failed).
H. RFDU battery (40). AC-powered with an automatic charger and a backup battery with one-month life.
I. RFDU entry/exit sensors (35). RFDU entry/exit sensors (35) are constantly on. Turns the RFDU on any time an employee enters or exits the restroom, so that RFID and RFDU can exchange information about compliance or noncompliance with the hand washing requirements.
   The functionality and capability of the RFDU (12)
1. Detect the employee's RFID at every entry to welcome the employee by name (LCD & speaker).
2. Communicates with the RFID at each exit to get the pass/fail status of the employee and immediately generate message of either appreciation for compliance or warning otherwise.
3. Keeps a real-time log of all entries, exits, and hygiene history of all employees.
4. Uploads history files to the company's main computers.
   The RFSU-1 (radiofrequency sanitization unit 1) (14) is this embodiment's interactive PCB (printed circuit board), which is embedded inside the faucet assembly. It is normally off and gets turned on by the RFSU-1 motion sensor (54), which is normally on, any time an employee approaches it and puts his hand under the faucet for cleansing substance dispensation. It emits detectable RF waves within a two feet radius or so and consists of a single board controller comprising the following components as shown in FIG. 4 and FIG. 5. The faucet assembly itself, also, houses the water spout (60), the cleansing substance spout (58), the motion sensor (54), and motion detector (56). (see FIGS. 4 and 5)
A. RFSU-1 microcontroller (72).
B. RFSU-1 database (68). Used to temporary store the monitored washing activities.
C. RFSU-1 radiofrequency circuit (64). Transceiver and internal antenna to communicate with the RFID.
D. RFSU-1 interface (70). Interface circuit to control external peripherals like the cleaning substance dispenser (76), the water valve (78), the motion detector (56), and any future input/output devices.
E. Large back-lit LCD to display the name of the engaged person and the steps of the hand washing process.
F. A speaker for added audible messaging.
G. AC-powered and automatic charger with a backup battery of one-month life.
H. RFSU-1 motion sensor (54). RFAU-1 motion sensor (54) is normally on. It has the dual function of turning RFAU-1 on any time an employee puts his/her hand under the faucet for dispensation of cleansing substance as well as the function of dispensation of cleansing substance.
   The functionality and capability of the RFSU-1:
1. Detects the employee's RFID (name, time stamps) as soon as the employee puts his hand under the faucet. That engages the motion sensor (54), which is constantly on and in turn turns the RFAU-1 on and gives a command to the cleaning substance dispenser (76) to dispense cleaning substance on the employee's hand. The RFSU-1 interrogates the RFID every second until the employee completes the hand washing sequence.
2. The RFSU-1 welcomes the employee by name (LCD & speaker) and walks him/her through the washing sequence, which is dispensing soap, rubbing hands while providing dripping water flow for achieving proper consistency of the cleaning substance, and rinsing under full water flow, all of them for programmable durations displayed for the employee in count-down timers.
3. Communicates with the RFID at the end of washing process to stamp it with pass/fail status.
4. If the washing sequence is not completed, the engaged RFID is stamped with a fail status.
5. Generates the appropriate messages, either appreciating compliance or warning otherwise.
6. One of the most vital aspects accomplished by the RFSU-1 is the enforcement part, which requires that the system monitors the actual hand washing sequence. Hands have to be rubbed for a period of 20 seconds after dispensation of cleansing substance. Monitoring of that activity is being achieved by the use of the RFSU-1 motion detector (56), which will stop the 20 sec. count down whenever hand rubbing motion is not being detected. Also, histograms of repetitive motions, which could be used to defeat this feature, have been eliminated from the countdown timing of the hand rubbing. During the 20 sec. of hand rubbing activity the water will flow at a slow, trickle flow rate for diluting the cleaning substance solution, if necessary, and as soon as the countdown is completed the water will start flowing at a normal rate for rinsing the cleansing substance off of one's hands. The reduction of the water flow rate could be achieved by intermittently opening and closing the water valve.

The RFSU-2 (radiofrequency sanitization unit 2) (16) is an optional unit with very similar functionally to the RFSU-1 (see FIG. 6). The main difference between the two units is that the RFSU-2 uses hand cleansing substances that do not require running water for rinsing them off, like alcohol based cleansers. All other functions are identical to RFSU-1. In most, but not all, instances the use of RFSU-2 is allowable instead of the use of RFSU-1.

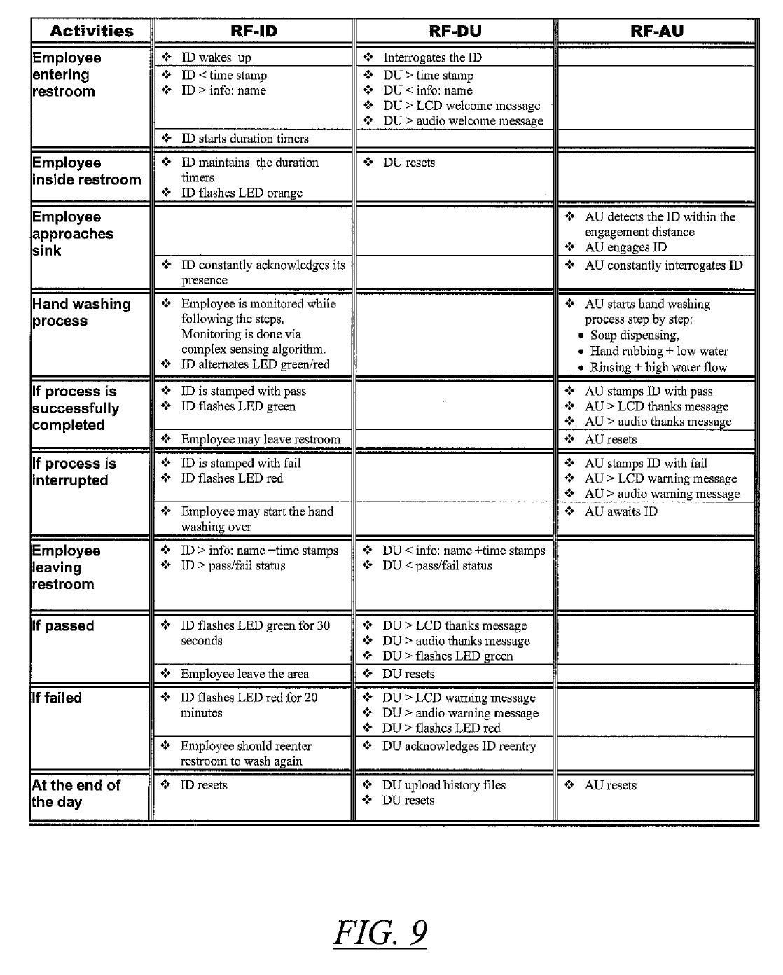

An example of a detailed algorithm, among many others, that achieves as an end result proper monitoring of employees' hand washing by using the Alternative embodiment is shown on FIG. 9

The preferred embodiment of the instant invention 10 monitors proper hand washing in an entire business entity. Examples of business entities in need of monitoring hand washing would be hospitals, food processing plants, hotels, restaurants, and many others. The primary embodiment consists of six main units. The first four units are identical to the four units described in the Alternative embodiment above, i.e. RFID (see description above), RFDU (see description above), RFSU-1 (see description above), and RFSU-2 (see description above). RFID in the Primary embodiment retains all the hand washing information of the person who wears it throughout his/her working day and then it transfers it to the RFDU on the way out of work. The last two units of the Primary embodiment are RFCU-1, and RFCU-2:

The RFCU-1 (radiofrequency contamination unit 1—see FIG. 7). RFCU-1 warns the person wearing the RFID that he/she must wash his/her hands within 10 seconds before engaging it and within 10 seconds after disengaging it. It allows more than one person to engage it at the same time. RFCU-1 must be attached to any person or object that must be dealt with, with clean hands. A perfect example of its use will be a patient. It emits detectable RE waves within a radius of two feet or so and consists of the following components as shown on FIG. 7:
A. PCB of RFCU-1 (Radio Frequency Contamination Unit 1) (18)
B. RFCU-1 radiofrequency circuit (106). Utilizes RF transceiver and internal antenna to communicate with the RFID.
C. RFCU-1 battery (108). AC-powered with or without battery charger as needed.
D. RFCU-1 battery charger (110). Battery charger could be used if attached to an object.
E. RFCU-1 data base (112). Used to store hygiene information, on a temporary bases, of all employees, who engage it.
F. RFCU 1 microcontroller (114)
   The functionality and capability of the RFCU 1:
1. Detects the employee's RFID as soon as the RFID is within the sphere of engagement of RFCU-1
2. Approves of the engagement with the RFID if the employee has washed his/her hands within 10 seconds before engaging it and warns said employee to wash his/her hands within 10 seconds after disengaging it.
3. Allows more than one person to engage it as long as said person(s) has washed his/her hands within 10 seconds before engaging it.
4. Keeps a real time log of all engagements for the last thirty days.
5. RFCU-1 could be used together the entry/exit sensors (35) of the alternative embodiment to monitor compliance with hand washing in restrooms. RFCU-1 would normally be off. The entry part of the entry/exit sensors (35) will not turn it on, so that the employees entering the restroom could enter undetected and unregistered. The exit part of the entry/exit sensors (35), however, will turn the RFCU 1 when the employee is exiting the restroom and, if the employee has not washed his/her hands within the previous 10 seconds as required, a default will be registered on his/her behalf

RFCU-2 (radiofrequency contamination unit 2—see FIG. 8). RFCU-2 emits detectable RF waves within a radius of two feet or so. After engaging an RFCU-2, it warns the person wearing the RFID to use an RFSU to wash his/her hands within 15 seconds after disengaging it. It allows more than one person to engage it at the same time. Examples of using RFCU-2s could be toilet bowls, urinals, contaminated equipment, etc. RFCU-2 consists of the following components, as shown on FIG. 8:
A. PCB of RFCU 2 (radiofrequency contamination unit 2) (20)
B. RFCU-2 radiofrequency circuit (116). Utilizes RF transceiver and internal antenna to communicate with RFID.
C. RFCU-2 battery (118). AC-powered with automatic charger and a battery of one month life.
D. RFCU-2 battery charger (120)
E. RFCU-2 data base (122). Used to store hygiene information on a temporary basis of all employees, who engage it.
F. RFCU 2 microcontroller (124)
   The functionality and capacity of RFCU-2:
1. Detects the employee's RFID as soon as the employee moves into the sphere of coverage of RFCU-2.
2. Interrogates the RFID every second for the duration its engagement with RFCU-2.
3. At the moment of disengagement with RFID advises employee he/she must wash his/her hands at an RFAU within the next 15 seconds.
4. Keeps a real time log of all engagements for the last thirty days.

A simplified and less detailed but more graphic way of understanding the operation of the primary embodiment of the Golden Faucet Hand Washing Enforcement System would be by picturing a mobile beacon(s) [RFID(s)—radiofrequency identification unit(s)], emitting RF (radiofrequency) waves of two feet in radius or so, moving among stationary beacons [RFCUs—radiofrequency contamination units; RFSUs—radiofrequency sanitization units; RFDU(s)—radiofrequency door unit(s)], emitting RF waves of two feet in radius or so, and by entering said stationary beacons' spheres of engagement, either by chance or design, and communicating with them said mobile beacon(s) makes a determination when hand washing is necessary. Then, after collecting and retaining all hand washing information throughout the working day, said mobile beacon(s) transfers said hand washing information at the end of the working day to the RFDU (radio frequency door unit) on the way out of work. The information received by the RFDU(s) from all RFIDs could be transferred real time, or through an USB unit, or through any other available technical means to a central data base for the management to review.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A hand washing monitoring system comprising:
means for monitoring proper hand washing frequency and technique comprising RF sensors;
said monitoring means comprising a microcontroller that processes information from RF signals and software based code of instructions;
at least one RF identification unit associated with an individual;
at least one RF stationary unit for detecting the entering and exiting of an individual; and
at least one RF sanitization unit disposed proximal a washing area for recording and transmitting information pertaining to the individuals hand washing process.

2. The system as recited in claim 1, further comprising:
at least one RF contamination unit attachable to a patient or position proximal the patient to warn the individual to wash their hands as they approach the RF contamination unit.
